(19) United States
(12) Patent Application Publication
(10) Pub. No.: US 2023/0219098 A1
(43) Pub. Date: Jul. 13, 2023

(54) DOMESTIC SHREDDER FOR PLASTIC PRODUCTS

(71) Applicant: Barbara Lynn Bennett, Murrieta, CA (US)

(72) Inventor: Barbara Lynn Bennett, Murrieta, CA (US)

(21) Appl. No.: 18/093,502

(22) Filed: Jan. 5, 2023

Related U.S. Application Data
(60) Provisional application No. 63/298,221, filed on Jan. 11, 2022.

(51) Int. Cl. B02C 18/14; B02C 18/22; B29B 17/04

(52) U.S. Cl. CPC B02C 18/148; B02C 18/2283; B29B 17/04; B29B 2017/044

(57) ABSTRACT

A shredding assembly for tearing a plastic article, such as waste bottles into pieces or pellets. The shredding assembly includes rails that can be installed at a height and a shredder. The shredder includes a housing mounted on the rails and can slide from a stowed position to over one or more trash bins. The shredder includes two rollers mounted within the housing and a drive mechanism for counter-rotating the two rollers.

### CROSS-REFERENCE TO RELATED APPLICATIONS

This application claims priority from a U.S. provisional patent application Ser. No. 63/298,221, filed on Jan. 11, 2022, which is incorporated herein by reference in its entirety.

### FIELD OF INVENTION

The present invention relates to a domestic portable shredder, and more particularly, the present invention relates to a portable and compact shredder for minimizing plastic products.

### BACKGROUND

Waste management is one of the biggest environmental challenges in the modern world. Enormously large amounts of waste are produced daily by both industries and homes. Plastic is very slow to decompose and forms a major part of daily waste, in particular plastic bottles. Much of the waste makes its way to the ecosystem, especially much of the waste ends up in the oceans. Recent studies reveal that about ten million plastic bottles end up in the ocean every year.

Management of domestic waste is both difficult and costly. The collection and transportation costs of domestic waste are generally extremely high. Moreover, the process is inefficient. To save transportation costs and prevent spillage of the waste, the size of the waste is reduced by shredding using shredders. However, such shredders are typically available at waste collection centers. The known shredders are generally made of bigger scales and are costly to manufacture and operate.

A need is therefore appreciated for a shredder that can be used at domestic levels for shredding most of the domestic waste so that the waste can be stored in lesser areas and transportation cost of the waste to collection centers can also be reduced.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a portable and compact shredder for plastic products.

It is another object of the present invention that the shredder is economical.

It is still another object of the present invention that the shredder can be manually operated.

It is yet another object of the present invention that the shredder is safer for use.

It is still another object of the present invention that the shredder does not occupy much of the floor.

It is a further object of the present invention that the shredder is easy to operate.

It is still a further object of the present invention that any complex or laborious setup is not needed.

In one aspect, disclosed is a shredding assembly for domestic use that can be portable, light in weight, easy to install, and can shred a variety of materials including plastic bottles, bags, and the like plastic domestic waste products.

In one aspect, disclosed is a shredding assembly comprising rails configured to be installed at a height; and a shredder. The shredder comprising a housing mounted on the rails and configured to slide on the rails; two rollers mounted within the housing, the two rollers are configured to tear a plastic article into pieces; and a drive mechanism for counter-rotating the two rollers. The drive mechanism comprises an electric motor. The drive mechanism further comprises a hand crank member configured to be hand cranked for counter-rotating the two rollers, wherein the drive mechanism is configured to be manually switched between the electric motor and the hand crank member. The shredding assembly further comprises a band heater spatially positioned relative to the two rollers, wherein the band heater comprises a hopper; a first section coupled to the hopper, the first section configured to be heated to a first temperature; and a second section coupled to the first section, wherein the second section is configured to be heated to a second temperature, wherein the second temperature is less than the first temperature. The hopper is configured to receive the pieces of the plastic article, wherein the band heater is configured to turn the pieces into pellets. The housing has an open top for receiving the plastic article, the shredder further comprises a hinged lid coupled to the housing for closing the open top, the lid configured to switch between an open state and a closed state. The shredder further comprises a sensor configured to detect the open state and the closed state of the lid.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a schematic view of the shredder assembly, according to an exemplary embodiment of the present invention.

FIG. 2 is a top view of the shredder assembly shown mounted above one of two trash bins, according to an exemplary embodiment of the present invention.

FIG. 3 is a perspective view of another implementation of the shredder assembly that is floor mounted, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting to embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed is a shredding assembly that can run on rails at a height from the ground. The disclosed shredding assembly is especially suited for small-scale shredding, such as for domestic purposes. The disclosed shredding assembly can be used to shred a variety of plastic domestic waste, such as plastic bottles, plastic bags, and the like plastic articles. The disclosed shredder can easily move above the trash bins, thus avoiding any need for moving the trash bins. The disclosed shredder can be operated through an electric motor as well as hand cranked, thus can be easily adapted to different domestic needs making the assembly versatile.

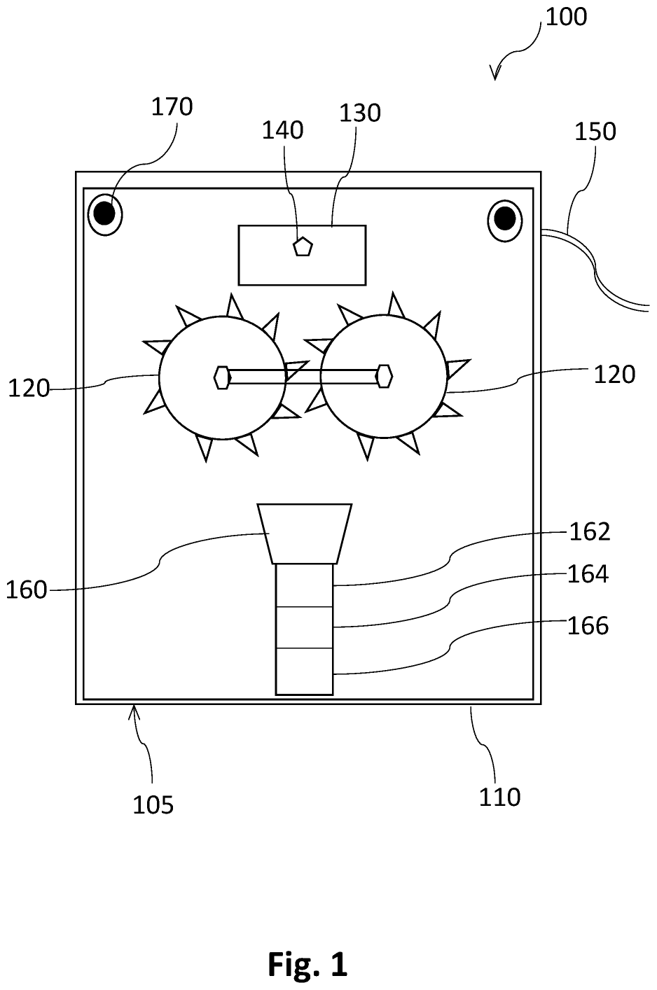

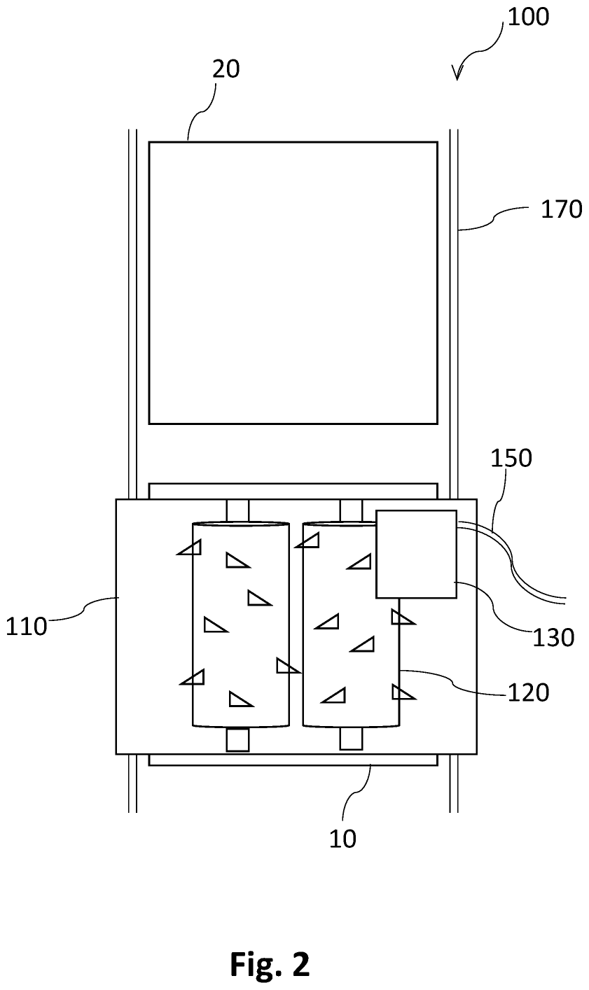

Referring to FIG. 1 is a schematic view of the disclosed shredding assembly 100 that includes a shredder 110 and a rail 170. The rail can be installed at a height above ground, and the shredder can be slidably mounted to the rail. The shredder can move from a stowed position to above a trash bin. Moreover, the shredder can be moved above a subsequent trash bin based on the type of waste. For example, plastic bottles and plastic bags can be collected in different trash bins. FIG. 2 shows the disclosed shredder assembly mounted to one of the two trash bins. The shredder can be moved on the rail from the first trash bin to the second trash bin.

The shredder has a housing 105 as shown in FIG. 1 which can be mounted on the rail 170. The shredder further includes two teethed rollers 120 that roll towards each other for drawing an item, crushing the item, and shredding the crushed item into pieces or chunks. The construction and working of such rollers are known in the art. Items such as plastic bottles to be shredded can be dropped over and between the two rollers. The teeth of the two counter-rotating rollers grab the item and pull it downwards between the rollers, and the item while passing through the rollers can be crushed and sliced into small chunks or pieces. These pieces can be collected in a trash bin that is separate from the disclosed assembly.

The shredder further comprises an electric motor 130 to drive the teethed rollers. The electric motor can be installed within the housing above or below the teethed rollers. Besides rollers, a hand crank member 140 can also be provided for counter-rotating the teethed rollers. A suitable gear mechanism can be used to interchangeably engage the teethed rollers to the electric motor or the hand crank. A lever can be provided that can be actuated to switch between the electric motor and the hand crank. For example, when or where electricity is not available, the hand crank mechanism can be used. The hand crank can include a handle that can be grabbed for rotating the crank. The hand crank can be mounted to a side of the housing so that it is reachable for hand cranking.

The counter-rotating teethed rollers and the electric motor can be installed within the housing. Some space can be available above the teethed rollers to receive the waste products for shredding. The waste products can be dropped from the open top of the housing over the teethed rollers. The open top can be closed by a lid. The lid can be pivotally coupled to the housing through hinge joints. Suitable locks can also be provided to secure the lid in the closed state. The locks can include sensors that can detect the locked state of the lid. The sensor in turn may be connected to the electric motor using a logic circuit such that the electric motor can only be operated when the lid is locked. This may ensure that the lid remains closed while operating the shredder to prevent any accidental drop of a thing into the shredder while operating the same.

In operation, a user can bring the shredder above a trash bin. Either the user can manually slide the shredder on the rails, or the shredder assembly can be provided with another electrical motor for moving the shredder on the rail. Once above the trash bin, the trash can be put into the shredder after lifting the lid. Thereafter, the lid can be closed, and the shredder can be started to shred the trash. Reduced trash pieces can drop into the trash bin. Once the trash has been shredded, the shredder can be moved above the next trash bin. The process can be repeated to collect the trash pieces into the second trash bin. FIG. 1 also shows a power cord 150 extending from the motor. The power cord can be connected to a power supply for powering the electric motor. It is also envisioned that suitable batteries can also be used to power the electric motor, and such batteries or any alternate means of powering the electric motor is within the scope of the present invention.

In certain implementations, the disclosed shredding assembly can be provided with a band heater. The output of the teethed rollers i.e., the shredded plastic chunks can be fed into the band heater for making the pellets. A chute 160 or hopper can collect the shredded plastic chunks i.e., the shredded plastic chunks from the counter-rotating teethed rollers can drop into the hopper. The band heater can apply graded heating to the plastic chuck starting from high to low for turning the shredded plastic chunks into pellets. FIG. 1 shows the first section 162 of the band heater that can be hot. The second section 164 can be warm, and the third section 166 can be at normal temperature. The pellets can be collected in a container. The band heater with the hopper can be mounted within the housing.

FIG. 2 shows a top view of the shredder assembly 100 wherein the shredder is shown mounted on two rails and above a first trash bin 10. A second trash bin 20 can also be seen adjacent to the first trash bin placed below the rails, such as the shredder can be moved over the second trash bin.

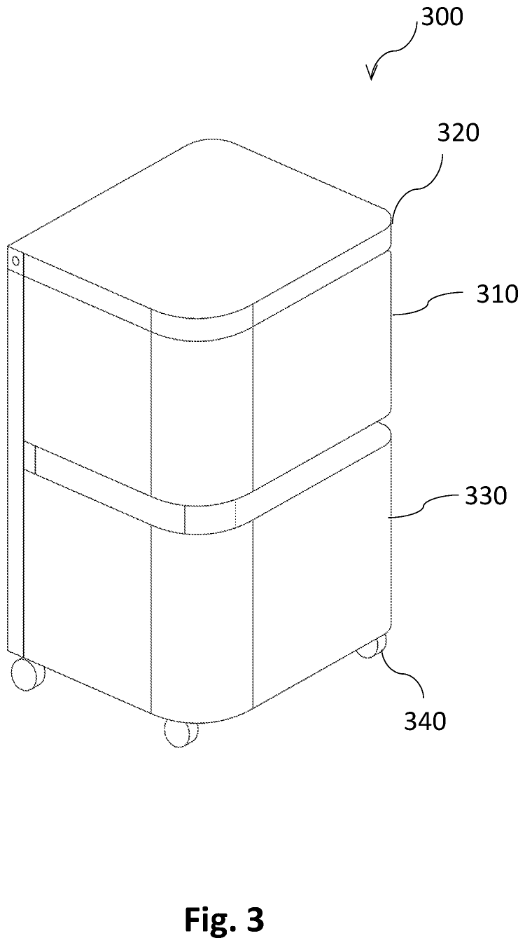

FIG. 3 shows another implementation of the disclosed shredding assembly 300 that can be floor mounted. The disclosed assembly 300 includes a housing 310 that encases the motor and cutting rollers. The housing has an open top through which plastic articles can be dropped above the rollers. The open top is closed by a hinged lid 320 which has a lock and a sensor as described above for the assembly 100. Below the housing can be a bin 330 into which minimized plastic pieces from the rollers can be collected. The bin is supported on a frame that can be a part of the housing. The bin can be taken out from the housing for disposing of the plastic chunks. Wheels 340 can also be provided for moving the assembly 300.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A shredding assembly comprising:
rails configured to be installed at a height; and
a shredder, the shredder comprising:
a housing mounted on the rails and configured to slide on the rails;
two rollers mounted within the housing, the two rollers are configured to tear a plastic article into pieces; and
a drive mechanism for counter-rotating the two rollers.

2. The shredding assembly according to claim 1, wherein the drive mechanism comprises an electric motor.

3. The shredding assembly according to claim 2, wherein the drive mechanism further comprises:
a hand crank member configured to be hand cranked for counter-rotating the two rollers, wherein the drive mechanism is configured to be manually switched between the electric motor and the hand crank member.

4. The shredding assembly according to claim 1, wherein the shredding assembly further comprises:
a band heater spatially positioned relative to the two rollers, wherein the band heater comprises:
a hopper;
a first section coupled to the hopper, the first section configured to be heated to a first temperature; and
a second section coupled to the first section, wherein the second section is configured to be heated to a second temperature, wherein the second temperature is less than the first temperature.

5. The shredding assembly according to claim 4, wherein the hopper is configured to receive the pieces of the plastic article, wherein the band heater is configured to turn the pieces into pellets.

6. The shredding assembly according to claim 4, wherein the housing has an open top for receiving the plastic article, the shredder further comprises a hinged lid coupled to the housing for closing the open top, the hinged lid configured to switch between an open state and a closed state.

7. The shredding assembly according to claim 6, wherein the shredder further comprises a sensor configured to detect the open state and the closed state of the hinged lid.

8. A method for shredding a plastic article into pieces, the method comprises:
providing a shredding assembly comprising:
rails configured to be installed at a height, and
a shredder, the shredder comprising:
a housing mounted on the rails and configured to slide on the rails,
two rollers mounted within the housing, the two rollers are
configured to tear a plastic article into pieces, and
a drive mechanism for counter-rotating the two rollers.

9. The method according to claim 8, wherein the drive mechanism comprises an electric motor.

10. The method according to claim 9, wherein the drive mechanism further comprises:
a hand crank member configured to be hand cranked for counter-rotating the two rollers, wherein the drive mechanism is configured to be manually switched between the electric motor and the hand crank member.

11. The method according to claim 8, wherein the shredding assembly further comprises:
a band heater spatially positioned relative to the two rollers, wherein the band heater comprises:
a hopper;
a first section coupled to the hopper, the first section configured to be heated to a first temperature; and
a second section coupled to the first section, wherein the second section is configured to be heated to a second temperature, wherein the second temperature is less than the first temperature.

12. The method according to claim 11, wherein the hopper is configured to receive the pieces of the plastic article, wherein the band heater is configured to turn the pieces into pellets.

13. The method according to claim 11, wherein the housing has an open top for receiving the plastic article, the shredder further comprises a hinged lid coupled to the housing for closing the open top, the hinged lid configured to switch between an open state and a closed state.

14. The method according to claim 13, wherein the shredder further comprises a sensor configured to detect the open state and the closed state of the hinged lid.
